(19) United States
(12) Patent Application Publication
(10) Pub. No.: US 2015/0220015 A1
(43) Pub. Date: Aug. 6, 2015

(54) LIQUID DEVELOPER

(71) Applicant: KONICA MINOLTA, INC., Chiyoda-ku (JP)

(72) Inventors: Yuya KUBO, Hachioji-shi (JP); Chiaki YAMADA, Ibaraki-shi (JP); Masahiro ANNO, Sakai-shi (JP); Kazuyoshi GOAN, Sagamihara-shi (JP)

(73) Assignee: KONICA MINOLTA, INC., Tokyo (JP)

(21) Appl. No.: 14/608,352

(22) Filed: Jan. 29, 2015

(30) Foreign Application Priority Data
Feb. 3, 2014 (JP) 2014-018499

(51) Int. Cl. G03G 9/12

(52) U.S. Cl. CPC G03G 9/122

(57) ABSTRACT

A liquid developer includes an insulating liquid and toner particles which are dispersed in the insulating liquid and contain a resin and a coloring agent. The coloring agent contains nigrosine and a pigment derivative, and preferably further contains carbon black. Preferably, Wn and Ws satisfy relation of 0.15≦Ws/Wn≦0.80, where Wn represents a ratio of content (mass %) of nigrosine in the toner particles and Ws represents a ratio of content (mass %) of the pigment derivative in the toner particles.

This application is based on Japanese Patent Application No. 2014-018499 filed with the Japan Patent Office on Feb. 3, 2014, the entire content of which is hereby incorporated by reference.

### BACKGROUND OF THE INVENTION

1. Field of the Invention

The present invention relates to a liquid developer.

2. Description of the Related Art

A liquid developer includes an insulating liquid and toner particles which are dispersed in the insulating liquid and contain a resin and a coloring agent. Therefore, the toner particles can be prevented from scattering in atmosphere even when a particle size of the toner particles is made smaller. Since the liquid developer can be smaller in particle size of toner particles than a developer used in dry electrophotography (a dry developer), an image excellent in image quality is obtained. For example, since toner particles having a core/shell structure described in Japanese Laid-Open Patent Publication No. 2009-096994 have a small diameter and uniform particle size distribution, they are suitable as toner particles to be contained in a liquid developer.

In order to obtain an image excellent in image density with the use of a liquid developer, a content of a coloring agent should be increased. When a material excellent in conductivity such as carbon black is employed as a coloring agent, however, increase in content of a coloring agent results in lowering in resistance of toner particles and toner particles are less likely to be charged. Then, unsatisfactory transfer (for example, lowering in a ratio of transfer) is caused. In addition, increase in content of carbon black leads to lowering in a degree of gloss of an image due to a filler effect. From the foregoing, it is difficult to obtain an image having desired image density also when a content of carbon black is increased.

Since nigrosine is higher in coloring capability than an organic pigment, a content of nigrosine can be kept low. In addition, nigrosine is lower in conductivity than carbon black. From the foregoing, use of nigrosine as a coloring agent can prevent lowering in resistance of toner particles and can hence prevent unsatisfactory transfer. Furthermore, increase in content of nigrosine can increase a degree of gloss of an image, which has been found to be effective for controlling a degree of gloss (Japanese Laid-Open Patent Publication No. 2001-011055).

### SUMMARY OF THE INVENTION

It has been found that, when a liquid developer containing nigrosine is stored for a long period of time, some of a nigrosine component is eluted into the insulating liquid and consequently the insulating liquid is colored. Therefore, it has been found that, when an image is formed with the use of the liquid developer containing nigrosine, a portion of a recording medium where no image is formed (hereinafter denoted as a “non-image portion”) is colored as being reddish.

The present invention was made in view of such aspects, and an object of the present invention is to provide a liquid developer with which a nigrosine component is less likely to be eluted into an insulating liquid even after storage for a long period of time.

A liquid developer according to the present invention includes an insulating liquid and toner particles which are dispersed in the insulating liquid and contain a resin and a coloring agent. The coloring agent contains nigrosine and a pigment derivative, and preferably further contains carbon black.

Preferably, Wn and Ws satisfy relation of 0.15≦Ws/Wn≦0.80, where Wn represents a ratio of content (mass %) of nigrosine in the toner particles and Ws represents a ratio of content (mass %) of the pigment derivative in the toner particles.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic conceptual diagram of an image formation apparatus of an electrophotography type.

### DESCRIPTION OF THE PREFERRED EMBODIMENTS

A liquid developer according to the present invention will be described below. In the drawings of the present invention, the same or corresponding elements have the same reference characters allotted. Relation of such a dimension as a length, a width, a thickness, or a depth is modified as appropriate for clarity and brevity of the drawings and does not represent actual dimensional relation.

[Liquid Developer]

A liquid developer according to the present embodiment is useful as a liquid developer for electrophotography used in an image formation apparatus of an electrophotography type (which will be described later) such as a copying machine, a printer, a digital printer, or a simple printer, a paint, a liquid developer for electrostatic recording, an oil-based ink for ink jet printer, or an ink for electronic paper. The liquid developer according to the present embodiment contains an insulating liquid and toner particles which are dispersed in the insulating liquid and contain a resin and a coloring agent. Preferably, the liquid developer according to the present embodiment contains 10 to 50 mass % of toner particles and 50 to 90 mass % of the insulating liquid. The liquid developer according to the present embodiment may contain a thickener or a dispersant other than the toner particles and the insulating liquid.

<Toner Particles>

Toner particles contain a resin and a coloring agent dispersed in the resin. A content of each of the resin and the coloring agent in the toner particles is preferably determined such that desired image density is obtained when an amount of adhesion of toner particles to such a recording medium as paper is within a prescribed range. For example, toner particles preferably contain 20 mass % or more and 50 mass % or less of a coloring agent and more preferably contain 30 mass % or more and 40 mass % or less of a coloring agent. The toner particles may contain a dispersant for a pigment, a wax, or a charge control agent other than the resin and the coloring agent.

Toner particles have a median diameter D50 preferably not smaller than 0.5 μm and not greater than 5.0 μm. Such a median diameter D50 is smaller than a particle size of toner particles in a conventional dry developer and represents one of the features of the present invention. If a median diameter D50 of toner particles is not smaller than 0.5 μm, mobility of toner particles in electric field is good and development performance is kept high. If a median diameter D50 of toner particles is not greater than 5.0 μm, a particle size of toner particles is uniform and hence an image high in quality is obtained. More preferably, toner particles have a median diameter D50 not smaller than 0.5 μm and not greater than 2.0 μm. “Median diameter D50 of toner particles” means a median diameter D50 found through measurement of particle size distribution of toner particles based on volume.

An average value of circularity (average circularity) of toner particles is preferably not lower than 0.85 and not higher than 0.95 and a standard deviation of circularity is preferably not lower than 0.01 and not higher than 0.1. Thus, a ratio of transfer is high and ease of cleaning improves. “Circularity of toner particles” means a value obtained by dividing a circumferential length of a circle equal in area to a projection area of toner particles by a circumferential length of sensed toner particles. “Average circularity of toner particles” means an arithmetic mean value of circularity of toner particles.

Median diameter D50 of toner particles, average circularity of toner particles, and a standard deviation of circularity of toner particles can all be measured, for example, with a flow particle image analyzer (for example, a trade name “FPIA-3000S” manufactured by Sysmex Corporation). This analyzer can use an insulating liquid as a dispersion medium. Therefore, this analyzer can measure a median diameter D50 of toner particles in a state that toner particles are dispersed in the insulating liquid, as compared with measurement with water being employed as a dispersion medium.

<Coloring Agent>

A coloring agent contains nigrosine and a pigment derivative. Nigrosine is excellent in affinity with a pigment derivative. Therefore, it is considered that, as the coloring agent contains not only nigrosine but also a pigment derivative, the pigment derivative is adsorbed onto a surface of nigrosine and consequently it is considered that a nigrosine component can be prevented from being eluted into an insulating liquid. Thus, elution of a nigrosine component into an insulating liquid can be prevented even when a liquid developer is stored for a long period of time. Therefore, reddish coloring of a non-image portion can be prevented.

The coloring agent preferably further contains carbon black. Thus, an image higher in image density can be obtained and an image having a desired hue (for example, black) can be obtained. In order to effectively obtain such an effect, toner particles contain preferably 10 mass % or more and 40 mass % or less of carbon black and contain more preferably 10 mass % or more and 30 mass % or less of carbon black.

<Nigrosine>

“Nigrosine” is a mixture of various types of azine based compounds which can be obtained by subjecting aniline, aniline hydrochloride, and nitrobenzene to oxidation-reduction condensation in the presence of such a catalyst as iron chloride. A main component of nigrosine is an azine based compound which is a purple-black dye having a skeleton formed by phenazine, phenazine azine, triphenazine oxazine, or the like.

Such nigrosine can be exemplified, for example, by C. I. Solvent Black 7, C. I. Solvent Black 5, or various azine based compounds. One type or two or more types of materials below can be employed as nigrosine in the present embodiment.

As C. I. Solvent Black 5, for example, a commercially available product under such a trade name as “Spirit Black SB,” “Spirit Black SSBB,” “Spirit Black AB,” “Spirit Black ABL,” “NUBIAN BLACK NH-805,” or “NUBIAN BLACK NH-815” manufactured by Orient Chemical Industries Co., Ltd. can be exemplified.

As C. I. Solvent Black 7, for example, a commercially available product under such a trade name as “Nigrosine Base SA,” “Nigrosine Base SAP,” “Nigrosine Base SAPL,” “Nigrosine Base EE,” “Nigrosine Base EEL,” “Nigrosine Base EX,” “Nigrosine Base EXBP,” “Special Black EB,” “NUBIAN BLACK TN-870,” “NUBIAN BLACK TN-877,” “NUBIAN BLACK TH-807,” “NUBIAN BLACK TH-827,” or “NUBIAN GREY IR-B” manufactured by Orient Chemical Industries Co., Ltd. can be exemplified.

As the azine based compound, for example, a commercially available product under such a trade name as “BONTRON N-01”, “BONTRON N-04”, “BONTRON N-07”, “BONTRON N-09”, “BONTRON N-21”, “BONTRON N-71”, “BONTRON N-75”, or “BONTRON N-79” manufactured by Orient Chemical Industries Co., Ltd. can be exemplified.

<Pigment Derivative>

A pigment derivative has any of compositions 1 to 3 below. Preferably, the pigment derivative has any of the compositions 1 to 3 below and a composition 4 below.

Composition 1: A compound producing van der Waals force between a pigment derivative and a coloring agent

Composition 2: A compound having a skeleton the same in structure as a coloring agent, producing a π-π interaction between the pigment derivative and the coloring agent, and firmly adsorbed onto a surface of the coloring agent

Composition 3: A compound having a skeleton the same in structure as a pigment, in which an acid group (for example, a sulfate group or an amino group) is introduced in a molecule forming the pigment

Composition 4: A compound exhibiting a strong interaction also with a high-polymer dispersant. The high-polymer dispersant has affinity with a solvent or a resin used in dispersion of a coloring agent. Since molecules of the high-polymer dispersant are bulky, the high-polymer dispersant prevents reaggregation of the coloring agent.

Here, a “compound having a skeleton the same in structure as a coloring agent” includes also a compound the same in chemical structure except for some functional groups or some substituents, which is also the case with a “compound having a skeleton the same in structure as a pigment.”

Preferably, the pigment derivative is a compound having a phthalocyanine structure having a metal atom as a central atom. The pigment derivative and the high-polymer dispersant are conventionally bonded to each other owing to an acid-base interaction. If the pigment derivative in the present embodiment has the phthalocyanine structure, however, the high-polymer dispersant (an electron donor compound) gives electrons to the central atoms in the phthalocyanine structure and the high-polymer dispersant and the pigment derivative will more firmly be bonded to each other through a coordinate bond. Therefore, the pigment derivative and the high-polymer dispersant are firmly bonded to each other without being affected by a polarity of a solvent or a functional group of an added resin. The high-polymer dispersant exhibits affinity with a dispersion medium (a solvent or a resin used in dispersion of a coloring agent) and prevents reaggregation of the coloring agent because molecules thereof are bulky. Therefore, the high-polymer dispersant can lower viscosity of a dispersion liquid of a coloring agent which contains a resin and a coloring agent in a solvent in which a resin has been dissolved.

Such a pigment derivative can be exemplified by a metal phthalocyanine having any one of Cr, Fe, Co, Ni, Zn, Mn, Mg, and Al as a central atom or a metal phthalocyanine derivative. The metal phthalocyanine derivative means a compound in which a hydrogen atom contained in a benzene ring of a phthalocyanine is substituted with an atom different from the hydrogen atom (for example, a halogen atom) or an atom group. The atom group can be exemplified, for example, by a hydrocarbon group such as a methyl group or a vinyl group, a hydroxyl group, a carboxyl group, or an amino group. The metal phthalocyanine and the metal phthalocyanine derivative are hereinafter collectively denoted as “metal phthalocyanines”.

By way of example of metal phthalocyanines, for example, a trade name “Solsperse 5000” or “Solsperse 12000” manufactured by The Lubrizol Corporation, a trade name “BYK-Synergist 2100” manufactured by BYK Japan KK, or a trade name “EFKA 745” manufactured by EFKA CHEMICALS B. V. can be exemplified.

The pigment derivative may be an azo pigment derivative, without being limited to metal phthalocyanines. For example, an azo pigment derivative can also be exemplified, for example, by a trade name “Solsperse 22000” manufactured by The Lubrizol Corporation or a trade name “EFKA 6750” manufactured by EFKA CHEMICALS B. V. One type or two or more types of the materials above can be employed as the pigment derivative in the present embodiment.

<Ratio of Content Between Nigrosine and Pigment Derivative>

Preferably, Wn and Ws satisfy relation of 0.15≦Ws/Wn≦0.80, where Wn represents a ratio of content (mass %) of nigrosine in the toner particles and Ws represents a ratio of content (mass %) of the pigment derivative in the toner particles. More preferably, Wn and Ws satisfy relation of 0.20≦Ws/Wn≦0.80.

When relation of 0.15≦Ws/Wn is satisfied, a ratio of content of the pigment derivative in the toner particles is high and hence an effect of the present embodiment (elution of a nigrosine component into an insulating liquid can effectively be prevented even when a liquid developer is stored for a long period of time) can effectively be obtained. When relation of Ws/Wn≦0.80 is satisfied, a high ratio of content of nigrosine in the toner particles can be ensured and hence an image excellent in glossiness and a hue can be obtained.

A ratio of content Wn of nigrosine in the toner particles is preferably not lower than 5 mass % and not higher than 30 mass % and more preferably not lower than 5 mass % and not higher than 21 mass %. When Wn is not lower than 5 mass %, an image excellent in glossiness and a hue can be obtained. When Wn is not higher than 30 mass %, a red hue originating from nigrosine can be prevented from being intensified and an image having a desired hue is obtained.

A ratio of content Ws of the pigment derivative in the toner particles is preferably not lower than 2 mass % and not higher than 16 mass %. When Ws is not lower than 2 mass %, an effect of addition of the pigment derivative can effectively be obtained. When Ws is not higher than 16 mass %, too low a ratio of content Wn of nigrosine in the toner particles can be prevented and hence an image excellent in glossiness and a hue can be obtained.

Wn and Ws can be determined in accordance with proton nuclear magnetic resonance (NMR), infrared spectroscopy, or pyrolysis gas chromatograph mass spectrometer (GCMS) analysis. When two or more types of materials are employed as nigrosine, a total of ratios of content of nigrosine in the toner particles is defined as Wn. When two or more types of materials are employed as the pigment derivative, a total of ratios of content of the pigment derivative in the toner particles is defined as Ws.

<Carbon Black>

“Carbon black” is a collective denotation of black fine particles mainly composed of carbon. Though carbon black may chemically be categorized into elemental carbon, it may contain various functional groups as is well known. Such carbon black can be exemplified, for example, by thermal black, acetylene black, channel black, furnace black, lamp black, or aniline black.

Such carbon black may be subjected to surface treatment for altering a characteristic of a surface as necessary. Conventionally known various methods can be adopted as a treatment method, and preferably, a wet surface treatment method of immersing carbon black in an acid solution such as an acetic acid solution or a sulfonic acid solution or a dry surface treatment method without using a liquid can be exemplified. The dry surface treatment method can be exemplified by a method of contact with nitric acid, a gas mixture of nitrogen oxide and air, or an oxidizer such as ozone, or an air oxidation method. Some commercially available carbon black of which pH has been adjusted has already been marketed.

Preferred specific examples of carbon black can be exemplified by “#2400”, “#2400B”, “#2650”, “OIL7B”, “MA77”, “MA100”, “MA100S”, or “PCF#10” manufactured by Mitsubishi Chemical Corporation, “Black Pearls L”, “MOGUL L”, “MONARCH 1300”, “MONARCH 1400”, “REGAL 330R”, “REGAL 400R”, or “MONARCH 1100” manufactured by Cabot Corporation, or “Printex V”, “Special Black 4,” or “Printex 140V” manufactured by Degussa (an item in “ ” above representing a trade name). One type or two or more types of such materials can be employed as carbon black. When two or more types of the materials above are employed as carbon black, a total amount thereof is preferably within the range above.

<Organic Pigment>

A coloring agent preferably further contains an organic pigment, separately from nigrosine and a pigment derivative. Thus, a toned image can be obtained. In addition, an image higher in image density can be obtained.

A conventionally known organic pigment can be employed as the organic pigment without particularly being limited, however, from a point of view of cost, resistance to light, and coloring capability, organic pigments shown below are preferably employed. In terms of color construction, the organic pigments are normally categorized into a yellow pigment, a magenta pigment, and a cyan pigment as shown below. One type or two or more types of materials below can be employed as the organic pigment.

A yellow pigment can be exemplified, for example, by color index (C. I) Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 138, C. I. Pigment Yellow 155, C. I. Pigment Yellow 180, or C. I. Pigment Yellow 185.

A magenta pigment can be exemplified, for example, by C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, or C. I. Pigment Red 222.

A cyan pigment can be exemplified, for example, by C. I. Pigment Blue 15, C. I. Pigment Blue 15:2, C. I. Pigment Blue 15:3, C. I. Pigment Blue 15:4, C. I. Pigment Blue 16, C. I. Pigment Blue 60, C. I. Pigment Blue 62, C. I. Pigment Blue 66, or C. I. Pigment Green 7.

<Resin>

A resin can be exemplified, for example, by a polyester resin, a polyurethane resin, a styrene acrylic resin, or a modified polyester resin. By way of example of the modified polyester resin, a urethane-modified polyester resin (a resin resulting from increase in chain length of a component derived from a polyester resin by a compound containing an isocyanate group) can be exemplified. One type or two or more types of such materials can be employed as a resin to be contained in toner particles.

<Core/Shell Structure>

Toner particles preferably have a core/shell structure. The “core/shell structure” is such a structure as having a first resin as a core and a second resin as a shell. The core/shell structure includes not only such a structure that the second resin covers at least a part of surfaces of first particles (the first particles containing the first resin) but also such a structure that the second resin adheres to at least a part of surfaces of the first particles. As the toner particles have the core/shell structure, a median diameter D50 of toner particles and circularity of toner particles are readily controlled.

In the core/shell structure, a mass ratio between a shell resin (the second resin) and a core resin (the first resin) is preferably from 1:99 to 20:80. When 1 mass % or more of the shell resin is contained in the resin of the toner particles, it is easy to form the core/shell structure. When 20 mass % or less of the shell resin is contained in the resin of the toner particles, a liquid developer excellent in fixability is obtained.

The shell resin can be exemplified, for example, by a thermoplastic resin or a thermosetting resin. More specifically, for example, a vinyl resin, a polyester resin, a polyurethane resin, an epoxy resin, a polyamide resin, a polyimide resin, a silicon resin, a phenol resin, a melamine resin, a urea resin, an aniline resin, an ionomer resin, or a polycarbonate resin can be exemplified. One type or two or more types of such materials can be employed as the shell resin.

The core resin can be exemplified, for example, by a polyester resin, a polyurethane resin, a styrene acrylic resin, or a modified polyester resin. One type or two or more types of such materials can be employed as the core resin.

In the core/shell structure, a coloring agent may be contained in the core resin or the shell resin, or in both of the core resin and the shell resin. This is also the case with an additive (for example, a dispersant for pigment) to toner particles.

<Dispersant for Pigment>

A dispersant for pigment serves to uniformly disperse a pigment in toner particles in a stable manner and it is preferably a basic dispersant for pigment.

The basic dispersant for pigment refers to a dispersant defined below. Namely, 0.5 g of a dispersant for pigment and 20 ml of distilled water are introduced in a screw bottle made of glass, the screw bottle is shaken for 30 minutes with the use of a paint shaker, and the resultant product is filtered. pH of a filtrate obtained through filtration is measured with a pH meter (trade name: “D-51” manufactured by Horiba, Ltd.), and a filtrate of which pH is higher than 7 is defined as a basic dispersant for pigment. It is noted that a filtrate of which pH is lower than 7 is referred to as an acid dispersant for pigment.

Such a basic dispersant for pigment can be exemplified, for example, by a compound (dispersant) having at least one functional group of an amine group, an amino group, an amide group, a pyrrolidone group, an imine group, an imino group, a urethane group, a quaternary ammonium group, an ammonium group, a pyridino group, a pyridium group, an imidazolino group, and an imidazolium group in a molecule of the dispersant. It is noted that what is called a surfactant having a hydrophilic portion and a hydrophobic portion in a molecule normally falls under the dispersant, however, various compounds can be employed, so long as they have a function to disperse a pigment.

A commercially available product of such a basic dispersant for pigment can be exemplified, for example, by “Ajisper PB-821” (trade name), “Ajisper PB-822” (trade name), or “Ajisper PB-881” (trade name), manufactured by Ajinomoto Fine-Techno Co., Inc., or “Solsperse 28000” (trade name), “Solsperse 32000” (trade name), “Solsperse 32500” (trade name), “Solsperse 35100” (trade name), or “Solsperse 37500” (trade name), manufactured by Japan Lubrizol Limited. One type or two or more types of such materials can be employed as the dispersant for pigment. More preferably, a material not dissolved in an insulating liquid or “Ajisper PB-821” (trade name), “Ajisper PB-822” (trade name), or “Ajisper PB-881” (trade name) manufactured by Ajinomoto Fine-Techno Co., Inc. is employed as the dispersant for pigment. It has been found that, by using such a dispersant for pigment, toner particles are easily designed to have a desired shape, although a detailed mechanism is unclear.

Preferably 1 to 100 mass % and more preferably 1 to 40 mass % of a dispersant for pigment is added to the pigment. When an amount of addition of the dispersant for pigment is lower than 1 mass %, dispersibility of the coloring agent may be insufficient, and hence necessary image density cannot be achieved in some cases and fixation strength may be lowered. When an amount of addition of the dispersant for pigment exceeds 100 mass %, the dispersant for pigment in an amount more than necessary for dispersing the pigment is added to the insulating liquid. Therefore, the excessive dispersant for pigment may be dissolved in the insulating liquid, which may lower chargeability or fixation strength of toner particles.

<Insulating Liquid>

The insulating liquid is preferably a solvent having a resistance value to such an extent as not distorting an electrostatic latent image (approximately from 10¹¹ to 10¹⁶ Ω·cm) and having low odor and toxicity. The insulating liquid can generally be exemplified by aliphatic hydrocarbon, alicyclic hydrocarbon, aromatic hydrocarbon, halogenated hydrocarbon, or polysiloxane, and from a point of view of odor, toxicity, and cost, a normal paraffin based solvent or an isoparaffin based solvent is preferably employed. For example, as the insulating liquid, Moresco White (a trade name, manufactured by MORESCO Corporation), Isopar (a trade name, manufactured by Exxon Mobil Corporation), Shellsol (a trade name, manufactured by Shell Chemicals Japan Ltd.), or IP Solvent 1620, IP Solvent 2028, or IP Solvent 2835 (each of which is a trade name and manufactured by Idemitsu Kosan Co., Ltd.) can be employed. One type or two or more types of such materials can be employed as the insulating liquid.

[Manufacturing of Liquid Developer]

Toner particles are manufactured based on such a known technique as a crushing method or a granulation method, and the obtained toner particles are dispersed in an insulating liquid. The liquid developer according to the present embodiment can thus be manufactured.

In the crushing method, a resin and a coloring agent such as a pigment are mixed and kneaded, and then the mixture is crushed. Such crushing is preferably carried out in a dry state or a wet state such as in oil.

The granulation method can be exemplified, for example, by a suspension polymerization method, an emulsion polymerization method, a fine particle aggregation method, a method of adding a poor solvent to a resin solution for precipitation, a spray drying method, or a method of forming toner particles having a core/shell structure with two different types of resins.

In order to obtain toner particles having a small diameter and sharp particle size distribution, the granulation method is preferably employed to manufacture toner particles. A resin high in meltability or a resin high in crystallinity is soft even at a room temperature. Therefore, it is difficult to crush a product obtained by mixing and kneading such a resin and a coloring agent such as a pigment. With the granulation method, toner particles containing such a resin can have a desired particle size.

Among the granulation methods, toner particles are preferably manufactured with a method shown below. Initially, a solution for forming a core resin is obtained by dissolving a resin in a good solvent. Then, the solution for forming a core resin above is mixed, together with an interfacial tension adjuster (a material for the shell resin), in a poor solvent different in SP value from the good solvent, shear is provided, and thus a droplet is formed. Thereafter, the good solvent is volatilized. Particles formed from the core resin are thus obtained. With this method, a particle size or a shape of toner particles can readily be controlled by varying how to provide shear, difference in interfacial tension, or an interfacial tension adjuster.

[Image Formation]

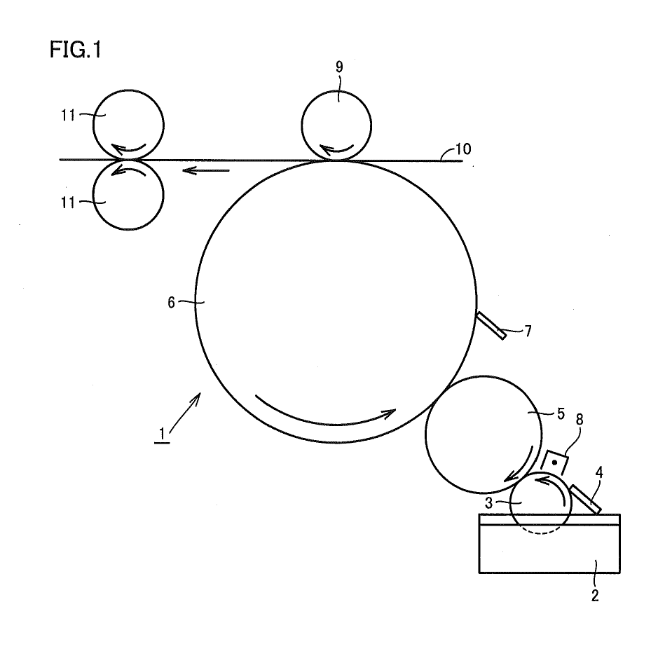

A construction of an apparatus for forming an image (image formation apparatus) which is formed by a liquid developer according to the present embodiment is not particularly limited. An image formation apparatus is preferably, for example, a monochrome image formation apparatus in which a monochrome liquid developer is primarily transferred from a photoconductor to an intermediate transfer element and thereafter secondarily transferred to a recording medium (see FIG. 1), an image formation apparatus in which a monochrome liquid developer is directly transferred from a photoconductor to a recording medium, or a multi-color image formation apparatus forming a color image by layering a plurality of types of liquid developers.

### EXAMPLES

Though the present invention will be described hereinafter in further detail with reference to Examples, the present invention is not limited thereto.

### Manufacturing Example 1

### Manufacturing of Dispersion Liquid of Shell Resin

In a beaker made of glass, 100 parts by mass of 2-decyltetradecyl (meth)acrylate, 30 parts by mass of methacrylic acid, 70 parts by mass of an equimolar reactant with hydroxyethyl methacrylate and phenyl isocyanate, and 0.5 part by mass of azobis methoxy dimethyl valeronitrile were introduced, and stirred and mixed at 20° C. Thus, a monomer solution was obtained.

Then, a reaction vessel to which a stirrer, a heating and cooling apparatus, a thermometer, a dropping funnel, a desolventizer, and a nitrogen introduction pipe were attached was prepared. In that reaction vessel, 195 parts by mass of THF were introduced, and the monomer solution above was introduced in the dropping funnel. After a vapor phase portion of the reaction vessel was replaced with nitrogen, the monomer solution was dropped in THF in the reaction vessel for 1 hour at 70° C. in a sealed condition. Three hours after the end of dropping of the monomer solution, a mixture of 0.05 part by mass of azobis methoxy dimethyl valeronitrile and 5 parts by mass of THF was added to the reaction vessel and caused to react for 3 hours at 70° C. Thereafter, cooling to room temperature was carried out. Thus, a copolymer solution was obtained.

Four hundred parts by mass of the copolymer solution were dropped in 600 parts by mass of IP Solvent 2028 (manufactured by Idemitsu Kosan Co., Ltd.) which was being stirred, and THF was distilled out at 40° C. at a reduced pressure of 0.039 MPa. Thus, a dispersion liquid of the shell resin was obtained. A volume average particle size of the particles in the dispersion liquid of the shell resin was measured with a laser particle size distribution analyzer (trade name “LA-920” manufactured by Horiba, Ltd.), which was 0.12 μm.

### Manufacturing Example 2

### Manufacturing of Solution for Forming Core Resin

In a reaction vessel to which a stirrer, a heating and cooling apparatus, and a thermometer were attached, 937 parts by mass of polyester (Mn: 6000) obtained from sebacic acid, adipic acid, and ethylene glycol (a molar ratio of 0.8:0.2:1) and 300 parts by mass of acetone were introduced and stirred, to thereby uniformly dissolve polyester in acetone. In this solution, 63 parts by mass of isophoron diisocyanate (IPDI) were introduced and caused to react for 6 hours at 80° C. When an NCO value of a product obtained through reaction attained to 0, 28 parts by mass of terephthalic acid were introduced and caused to react for 1 hour at 180° C. Thus, a core resin was obtained. Eight hundred parts by mass of the obtained core resin and 1200 parts by mass of acetone were introduced and stirred in a beaker, to thereby uniformly dissolve the core resin in acetone. Thus, a solution for forming the core resin was obtained. The obtained core resin had Mn of 25000, Mw of 45000, and a concentration of a urethane group of 1.44%.

In the present Example, Mn and Mw of a resin other than a polyurethane resin were measured with gel permeation chromatography (GPC) under conditions shown below, with respect to solubles in tetrahydrofuran (THF).

Measurement apparatus: “HLC-8120” manufactured by Tosoh Corporation

Column: “TSKgel GMHXL” (two) manufactured by Tosoh Corporation and “TSKgel Multipore HXL-M” (one) manufactured by Tosoh Corporation

Sample solution: 0.25 mass % of THF solution

Amount of injection of sample solution into column: 100

Flow rate: 1 ml/min.

Measurement temperature: 40° C.

Detection apparatus: Refraction index detector

Reference material: 12 standard polystyrenes manufactured by Tosoh Corporation (TSK standard POLYSTYRENE) (molecular weight: 500, 1050, 2800, 5970, 9100, 18100, 37900, 96400, 190000, 355000, 1090000, 2890000)

In the present Example, Mn and Mw of the polyurethane resin were measured with GPC under conditions shown below, with respect to solubles in THF.

Measurement apparatus: “HLC-8220GPC” manufactured by Tosoh Corporation

Column: “Guardcolumn a” (one) and “TSKgel a-M” (one)

Sample solution: 0.125 mass % of dimethylformamide solution

Amount of injection of dimethylformamide solution into column: 100

Flow rate: 1 ml/min.

Measurement temperature: 40° C.

Detection apparatus: Refraction index detector

Reference material: 12 standard polystyrenes manufactured by Tosoh Corporation (TSK standard POLYSTYRENE) (molecular weight: 500, 1050, 2800, 5970, 9100, 18100, 37900, 96400, 190000, 355000, 1090000, 2890000)

In the present Example, a concentration of a urethane group in the core resin was measured in accordance with a method shown below. Under conditions shown below (Conditions for Thermal Decomposition of Urethane-Modified Polyester Resin), a urethane-modified polyester resin was thermally decomposed. Then, a concentration of a urethane group in the core resin was measured with a GCMS under conditions shown below (Conditions for Measurement of Concentration of Urethane Group in Urethane-Modified Polyester Resin). Then, a concentration of a urethane group in the core resin was calculated by using a ratio of ion intensity detected from the thermally decomposed urethane-modified polyester resin.

(Conditions for Thermal Decomposition of Urethane-Modified Polyester Resin)

Apparatus: PY-2020iD manufactured by Frontier Laboratories Ltd.

Mass of Sample: 0.1 mg

Heating Temperature: 550° C.

Heating Time Period: 0.5 minute

(Conditions for Measurement of Concentration of Urethane Group in Urethane-Modified Polyester Resin)

Apparatus: GCMS-QP2010 manufactured by Shimadzu Corporation

Column: UltraALLOY-5 manufactured by Frontier Laboratories Ltd. (inner diameter: 0.25 mm, length: 30 m, thickness: 0.25 μm)

Temperature Increase Condition: Temperature Increase Range: 100° C. to 320° C. (held at 320° C.), Rate of Temperature Increase: 20° C./min.

### Manufacturing Example 3

### Manufacturing of Dispersion Liquid of Coloring Agent

In a beaker, 20 parts by mass of nigrosine (a trade name “NUBIAN BLACK TH-827” manufactured by Orient Chemical Industries Co., Ltd.), 10 parts by mass of a pigment derivative (a trade name “Solsperse 12000” manufactured by The Lubrizol Corporation), 70 parts by mass of carbon black (a trade name “Mogul L” manufactured by Cabot Corporation), 40 parts by mass of a dispersant for pigment (a trade name “Ajisper PB-821” manufactured by Ajinomoto Fine-Techno Co., Inc.), and 50 parts by mass of acetone were introduced and stirred, to thereby uniformly disperse these components in acetone. Thereafter, these components were finely dispersed with the use of a bead mill, to thereby obtain a dispersion liquid of a coloring agent. A volume average particle size of the mixed coloring agent contained in the dispersion liquid of the coloring agent was measured with a laser particle size distribution analyzer (a trade name “LA-920” manufactured by Horiba, Ltd.), which was 0.2 μm. The “volume average particle size of the mixed coloring agent” means an average value of a volume average particle size of nigrosine, a volume average particle size of a pigment derivative, and a volume average particle size of carbon black.

### Manufacturing Examples 4 to 18

### Manufacturing of Dispersion Liquid of Coloring Agent

Dispersion liquids of a coloring agent in Manufacturing Examples 4 to 18 were manufactured in accordance with the method shown in Manufacturing Example 3 except that a content of each of nigrosine, a pigment derivative, carbon black, and an organic pigment was changed to a value shown in Table 1.

TABLE 1

| | Formulation of Dispersion Liquid of Coloring Agent | | | | | | | | |
|---|---|---|---|---|---|---|---|---|---|
| | Nigrosine | | Pigment Derivative | | Carbon Black | | Organic Pigment | | |
| | (Parts by Mass) | | (Parts by Mass) | | (Parts by Mass) | | (Parts by Mass) | | |
| | NS1 | NS2 | S1 | S2 | CB1 | CB2 | Y | M | C |
| Manufacturing Example 3 | 20 | — | 10 | — | 70 | — | — | — | — |
| Manufacturing Example 4 | 20 | — | 10 | — | 44 | — | 9 | 9 | 9 |
| Manufacturing Example 5 | 24 | — | 19 | — | 57 | — | — | — | — |
| Manufacturing Example 6 | 33 | — | 10 | — | 57 | — | — | — | — |
| Manufacturing Example 7 | 45 | — | 34 | — | 21 | — | — | — | — |
| Manufacturing Example 8 | 31 | — | 6 | — | 63 | — | — | — | — |
| Manufacturing Example 9 | 20 | — | 10 | — | — | 70 | — | — | — |
| Manufacturing Example 10 | 20 | — | — | 10 | — | 70 | — | — | — |
| Manufacturing Example 11 | — | 20 | 10 | — | — | 70 | — | — | — |
| Manufacturing Example 12 | — | 20 | — | 10 | — | 70 | — | — | — |
| Manufacturing Example 13 | 41 | — | 6 | — | 53 | — | — | — | — |
| Manufacturing Example 14 | 21 | — | 17 | — | 62 | — | — | — | — |
| Manufacturing Example 15 | 86 | — | 14 | — | — | — | — | — | — |
| Manufacturing Example 16 | 57 | — | 43 | — | — | — | — | — | — |
| Manufacturing Example 17 | 43 | — | — | — | 57 | — | — | — | — |
| Manufacturing Example 18 | — | — | 43 | — | 57 | — | — | — | — |

In Table 1, “NS1” represents a trade name “NUBIAN BLACK TH-827” manufactured by Orient Chemical Industries Co., Ltd. and “NS2” represents a trade name “BONTRON N-09” manufactured by Orient Chemical Industries Co., Ltd. “S1” represents a trade name “Solsperse 12000” manufactured by The Lubrizol Corporation and “S2” represents a trade name “Solsperse 22000” manufactured by The Lubrizol Corporation. “CB1” represents a trade name “Mogul L” manufactured by Cabot Corporation and “CB2” represents a trade name “MA77” manufactured by Mitsubishi Chemical Corporation. “Y” represents a trade name “D1155” manufactured by BASF, “M” represents a trade name “Carmine 6B 401” manufactured by DIC Corporation, and “C” represents a trade name “Fastgen Blue FB5301” manufactured by DIC Corporation.

### Preparation of Liquid Developer

### Example 1

Twenty parts by mass of the solution for forming the core resin and 38 parts by mass of the dispersion liquid of the coloring agent in Manufacturing Example 3 were introduced in a beaker and stirred at 8000 rpm with the use of TK Auto Homo Mixer (manufactured by PRIMIX Corporation) at 25° C. Thus, a resin solution in which the coloring agent was uniformly dispersed was obtained.

In another beaker, 90 parts by mass of IP Solvent 2028 (manufactured by Idemitsu Kosan Co., Ltd.) and 12 parts by mass of the dispersion liquid of the shell particles were introduced, and the shell particles were uniformly dispersed. Thereafter, while TK Auto Homo Mixer was used at 25° C. to perform stirring at 10000 rpm, 60 parts by mass of the resin solution (the resin solution in which the coloring agent was uniformly dispersed) were introduced and stirred for 2 minutes. Thereafter, this liquid mixture was introduced in a reaction vessel to which a stirrer, a heating and cooling apparatus, a thermometer, and a desolventizer were attached, and a temperature was raised to 35° C. At a reduced pressure of 0.039 MPa at that temperature, acetone was distilled out until a concentration of acetone was not higher than 0.5 mass %. Thus, a liquid developer was obtained.

### Examples 2 to 14, Comparative Examples 1 and 2

Liquid developers in Examples 2 to 14 and Comparative Examples 1 and 2 were manufactured in accordance with the method described in Example 1 except that the dispersion liquids of the coloring agent shown in Table 2 were employed.

TABLE 2

| | Dispersion Liquid of Coloring Agent | | | | | | | | | | | | | | | |
|---|---|---|---|---|---|---|---|---|---|---|---|---|---|---|---|---|
| | | | Ratio of Content in Toner Particles (Mass %) | | | | | | | | | | | | | |
| | | Content | | | Pigment | | | | Organic | | | | | | | |
| | | (Parts by | Nigrosine (Wn) | | Derivative (Ws) | | Carbon Black | | Pigment | | | | | Fixed | Elu- | |
| | Type | Mass) | NS1 | NS2 | S1 | S2 | CB1 | CB2 | Y | M | C | Total | Ws/Wn | Image | tion | Hue |
| Example 1 | Manufacturing | 38 | 7 | — | 3.5 | — | 24.5 | — | — | — | — | 35 | 0.50 | A1 | A2 | A3 |
| | Example 3 | | | | | | | | | | | | | | | |
| Example 2 | Manufacturing | 38 | 7 | — | 3.5 | — | 15.5 | — | 3 | 3 | 3 | 35 | 0.50 | A1 | A2 | A3 |
| | Example 4 | | | | | | | | | | | | | | | |
| Example 3 | Manufacturing | 19 | 5 | — | 4 | — | 12 | — | — | — | — | 21 | 0.80 | A1 | A2 | A3 |
| | Example 5 | | | | | | | | | | | | | | | |
| Example 4 | Manufacturing | 19 | 7 | — | 2 | — | 12 | — | — | — | — | 21 | 0.29 | A1 | A2 | A3 |
| | Example 6 | | | | | | | | | | | | | | | |
| Example 5 | Manufacturing | 62 | 21 | — | 16 | — | 10 | — | — | — | — | 47 | 0.76 | A1 | A2 | A3 |
| | Example 7 | | | | | | | | | | | | | | | |
| Example 6 | Manufacturing | 65 | 15 | — | 3 | — | 30 | — | — | — | — | 48 | 0.20 | A1 | A2 | A3 |
| | Example 8 | | | | | | | | | | | | | | | |
| Example 7 | Manufacturing | 38 | 7 | — | 3.5 | — | — | 24.5 | — | — | — | 35 | 0.50 | A1 | A2 | A3 |
| | Example 9 | | | | | | | | | | | | | | | |
| Example 8 | Manufacturing | 38 | 7 | — | — | 3.5 | — | 24.5 | — | — | — | 35 | 0.50 | A1 | A2 | A3 |
| | Example 10 | | | | | | | | | | | | | | | |
| Example 9 | Manufacturing | 38 | — | 7 | 3.5 | — | — | 24.5 | — | — | — | 35 | 0.50 | A1 | A2 | A3 |
| | Example 11 | | | | | | | | | | | | | | | |
| Example 10 | Manufacturing | 38 | — | 7 | — | 3.5 | — | 24.5 | — | — | — | 35 | 0.50 | A1 | A2 | A3 |
| | Example 12 | | | | | | | | | | | | | | | |
| Example 11 | Manufacturing | 36 | 14 | — | 2 | — | 18 | — | — | — | — | 34 | 0.14 | A1 | B2 | A3 |
| | Example 13 | | | | | | | | | | | | | | | |
| Example 12 | Manufacturing | 36 | 7 | — | 6 | — | 21 | — | — | — | — | 34 | 0.86 | B1 | A2 | B3 |
| | Example 14 | | | | | | | | | | | | | | | |
| Example 13 | Manufacturing | 38 | 30 | — | 5 | — | — | — | — | — | — | 35 | 0.17 | B1 | A2 | B3 |
| | Example 15 | | | | | | | | | | | | | | | |
| Example 14 | Manufacturing | 41 | 21 | — | 16 | — | — | — | — | — | — | 37 | 0.76 | B1 | A2 | B3 |
| | Example 16 | | | | | | | | | | | | | | | |
| Comparative | Manufacturing | 38 | 15 | — | — | — | 20 | — | — | — | — | 35 | 0 | A1 | C2 | A3 |
| Example 1 | Example 17 | | | | | | | | | | | | | | | |
| Comparative | Manufacturing | 38 | — | — | 15 | — | 20 | — | — | — | — | 35 | — | A1 | A2 | C3 |
| Example 2 | Example 18 | | | | | | | | | | | | | | | |

In Table 2, “total” represents a total (mass %) of ratios of content of nigrosine, a pigment derivative, carbon black, and an organic pigment in toner particles.

<Image Formation>

An image was formed by using an image formation apparatus shown in FIG. 1. FIG. 1 is a schematic conceptual diagram of an image formation apparatus 1 of an electrophotography type. Initially, a liquid developer 2 is leveled off by a restriction blade 4 and a thin layer of liquid developer 2 is formed on a development roller 3. Thereafter, toner particles move at a nip between development roller 3 and a photoconductor 5 and a toner image is formed on photoconductor 5.

Then, the toner particles move at a nip between photoconductor 5 and an intermediate transfer element 6 and a toner image is formed on intermediate transfer element 6. In succession, toner is superimposed on intermediate transfer element 6, and an image is formed on coated paper (a recording medium) 10. The image on coated paper 10 is fixed by a heat roller 11.

Image formation apparatus 1 includes a cleaning blade 7, a charging apparatus 8, and a back-up roller 9, other than the above.

<Process Conditions>

System Speed: 40 cm/s

Photoconductor 5: Negatively charged organic photoconductor (OPC)

Charge Voltage: −700 V

Development Voltage (Voltage Applied to Development Roller): −450 V

Primary Transfer Voltage (Voltage Applied to Transfer Element): +600 V

Secondary Transfer Voltage: +1200 V

Pre-Development Corona CHG: Adjusted as appropriate between −3 and 5 kV of needle application voltage

An amount of adhesion of toner particles was adjusted such that image density of a black solid portion of a fixed image measured with a reflection densitometer (a trade name “X-Rite model 404” manufactured by X-Rite, Incorporated) was 1.7.

<Evaluation of Fixed Image>

A monochrome solid (filled) pattern (10 cm×10 cm) of each liquid developer in Examples and Comparative Examples was formed on coated paper 10 with the use of the image formation apparatus shown in FIG. 1 and under the process conditions described above, and then the pattern was fixed with the use of heat rollers 11 (180° C.×nip time of 30 msec.).

White paper was passed immediately after passage of coated paper 10 and whether or not the white paper was contaminated with toner was observed. A gloss meter (a trade name “VG-2000”) manufactured by Nippon Denshoku Industries Co., Ltd.) was used to measure a degree of gloss of the obtained image. Results are shown in “Fixed Image” in Table 2.

In Table 2, a case that white paper was not contaminated with toner and a degree of gloss was not lower than 60 is denoted as A1 and a case that white paper was not contaminated with toner but a degree of gloss was lower than 60 is denoted as B1. “White paper not contaminated with toner” means that occurrence of high-temperature offset is prevented. A higher degree of gloss indicates excellent glossiness of the fixed image.

<Evaluation of Presence or Absence of Elution>

Each liquid developer in Examples and Comparative Examples was stored at 50° C. for 24 hours, and then each liquid developer was subjected to solid-liquid separation with the use of a centrifuge (a trade name “H-9R” manufactured by Kokusan Co., Ltd.) (3500 rpm, 5 minutes). Thereafter, whether or not a supernatant was colored was checked. Whether or not a non-image portion of coated paper evaluated in <Evaluation of Fixed Image> above was colored was checked. Results are shown in “Elution” in Table 2.

In Table 2, a case that coloring was observed in neither of the supernatant and the non-image portion of coated paper is denoted as “A2”, a case that coloring was observed in the supernatant but not in the non-image portion of coated paper is denoted as “B2”, and a case that coloring was observed in both of the supernatant and the non-image portion of coated paper is denoted as “C2”. Absence of coloring in the supernatant and the non-image portion of coated paper indicates no elution of a nigrosine component into an insulating liquid.

<Evaluation of Hue>

A monochrome solid (filled) pattern of each liquid developer in Examples and Comparative Examples was formed on coated paper with the use of the image formation apparatus shown in FIG. 1 and under the process conditions described above and then the pattern was fixed with the use of heat rollers 11 (180° C.×nip time of 30 msec.).

A hue of the obtained monochrome solid pattern was evaluated with the use of a spectrophotometer (a trade name “CM-3700d” manufactured by Konica Minolta, Inc.). Specifically, a color difference EE between this monochrome solid pattern and Japan Color Color Reproduction Printing 2001 defined as the color standard for offset sheet-fed printing (type of paper: coated paper, manner: a site attaining a black dot area ratio of 100%) was calculated. Color difference ΔE was defined as a square root of the sum of squares of differences on the L* axis, the a* axis, and the b* axis in the uniform color space of the L*a*b* colorimetric system defined under JIS Z 8729 (see Expression (1) below). Results are shown in “hue” in Table 2.

ΔE=\sqrt{ΔL*²+Δa*²+Δb*²} Expression (1)

In Table 2, color difference ΔE lower than 3 is denoted as “A3”, color difference ΔE not lower than 3 and lower than 6 is denoted as “B3”, and color difference ΔE not lower than 6 is denoted as “C3”. A smaller color difference ΔE indicates a better hue.

### DISCUSSION

In Comparative Example 1, coloring of the supernatant and the non-image portion of coated paper was observed. It is considered that, since no pigment derivative is contained in the liquid developer in Comparative Example 1, a nigrosine component has been eluted into the insulating liquid during storage of the liquid developer for a long period of time. Therefore, it is considered that coloring of the supernatant and the non-image portion of coated paper was observed.

In Comparative Example 2, color difference ΔE was not lower than 6. It is considered that, since no nigrosine is contained in the liquid developer in Comparative Example 2, color difference ΔE was not lower than 6.

In Examples except for Example 11, coloring was observed in neither of the supernatant and the non-image portion of coated paper. In Example 11, though no coloring was observed in the non-image portion of coated paper, coloring of the supernatant was observed. The reason why such a result was obtained may be as follows. In Examples except for Example 11, Ws/Wn was not lower than 0.15, however, Ws/Wn was 0.14 in Example 11. Namely, Examples except for Example 11 were higher in ratio of content of the pigment derivative in the toner particles than Example 11. Therefore, an effect of prevention of seeping of nigrosine achieved by the pigment derivative was obtained more effectively in Examples except for Example 11 than in Example 11.

In Examples 1 to 11, white paper was not contaminated with toner, a degree of gloss was not lower than 60, and color difference ΔE was lower than 3. In Example 12, though white paper was not contaminated with toner, a degree of gloss was lower than 60 and color difference ΔE was not lower than 3 and lower than 6. The reason why such a result was obtained may be as follows. In Examples 1 to 11, Ws/Wn was not higher than 0.80, however, Ws/Wn was 0.86 in Example 12. Namely, Examples 1 to 11 were lower in ratio of content of nigrosine in the toner particles than Example 12. Therefore, Examples 1 to 11 obtained an image better in glossiness and hue than Example 12.

In Examples 13 and 14 as well, results the same as in Example 12 were obtained. The reason why such results were obtained may be as follows. In Examples 1 to 11, carbon black was contained, however, in Examples 13 and 14, carbon black was not contained. Therefore, Examples 1 to 11 obtained an image better in glossiness and hue than Examples 13 and 14.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A liquid developer, comprising:
an insulating liquid; and
toner particles which are dispersed in said insulating liquid and contain a resin and a coloring agent,
said coloring agent containing nigrosine and a pigment derivative.

2. The liquid developer according to claim 1, wherein
said coloring agent further contains carbon black.

3. The liquid developer according to claim 1, wherein
Wn and Ws satisfy relation of 0.15≦Ws/Wn≦0.80,
where Wn represents a ratio of content (mass %) of said nigrosine in said toner particles and Ws represents a ratio of content (mass %) of said pigment derivative in said toner particles.
